(19) United States
(12) Patent Application Publication
(10) Pub. No.: US 2014/0072251 A1
(43) Pub. Date: Mar. 13, 2014

(54) CAGELESS BEARINGS FOR USE WITH MECHANICAL DEVICES

(71) Applicants: Value Extraction LLC, Dearborn, MI (US); Szuba Consulting, Inc., Dearborn, MI (US)

(72) Inventor: Joseph Szuba, Dearborn, MI (US)

(73) Assignees: Value Extraction LLC, Dearborn, MI (US); Szuba Consulting, Inc., Dearborn, MI (US)

(21) Appl. No.: 14/021,251

(22) Filed: Sep. 9, 2013

Related U.S. Application Data
(60) Provisional application No. 61/697,928, filed on Sep. 7, 2012.

(51) Int. Cl. F16C 33/46; F16C 43/06; F16C 33/38

(52) U.S. Cl. CPC F16C 33/467; F16C 33/3887; F16C 43/065
USPC 384/445; 29/898.07

(57) ABSTRACT

A rotational assembly includes a mating surface and an interlocking surface disposed in driving engagement with a cooperable interlocking member of a driving mechanism. A plurality of receptors is defined in the mating surface. A bearing element is received in each of the plurality of receptors for reducing frictional interaction between the mating surface of the rotational assembly and a complimentary mating surface of an interacting component. A retainer is defined in the mating surface at each of the receptors providing rotational retention of each of the bearing elements within its corresponding receptor.

### PRIOR APPLICATION

The present application claims priority to U.S. provisional patent application No. 61/697,928 filed Sep. 7, 2012.

### BACKGROUND

The present application relates generally toward a method and apparatus for reducing friction. More specifically, the present application is directed toward the method and apparatus of reducing friction between adjacent surfaces of two components of a mechanical device moving in divergent directions.

Complex mechanical assemblies transferring motive force between various components have been known to provide poor efficiencies due to frictional forces between abutting components. For example, a modern automatic transmission for a vehicle makes use of various interlocking gears to transfer motive force from a vehicle motor to a drive shaft. Any of these complex components such as, for example, planetary carriers and gears, clutch housings, torque converters and the like include a thrust surface that is smooth but abutting an adjacent thrust surface. These thrust surfaces of adjacent components move in divergent directions resulting in a loss of efficiency due to frictional forces.

To reduce the negative effect of these frictional forces, roller bearing assemblies are inserted between adjacent thrust surfaces allowing the bearings disposed within the roller bearing assembly to support and reduce the frictional forces associated with movement in divergent directions between the adjacent surfaces. However, these roller bearing assemblies are known to be expensive and consume substantial packaging space resulting in longer and more costly transmissions assemblies. Furthermore, to improve vehicle efficiency, additional clutch housing and gear assemblies have been added to the vehicle transmissions without having additional packaging space in a vehicle assembly. Therefore, it would be desirable to provide the friction reducing benefits of a bearing in these complex assemblies without requiring the use of a costly, volumous roller bearing assembly presently in use.

### SUMMARY

A method of reducing friction between adjacent surfaces of two components of a mechanical device moving in divergent directions is disclosed. A plurality of receptors are formed in at least one of the adjacent surfaces. The receptors are arranged in succession corresponding to the divergent directions of the two components. A bearing element is inserted into each of the receptors with the bearing element supporting the adjacent surfaces of the two components. A clasp is formed at the receptors for retaining the bearing element within the receptor and allowing the bearing element to rotate relative to the adjacent surfaces for reducing friction between the adjacent surfaces when the adjacent surfaces are moving in divergent directions.

The present invention provides all of the friction reducing benefits of a bearing without the use of costly and space consuming roller bearing assemblies. The bearings are now affixed to one of the two adjacent components eliminating the need to install a roller bearing assembly between the two components. Not only is the cost of the roller bearing assembly housings and bearing cages eliminated, the space associated with these housings and cages is now made available to reduce the overall size of an associated mechanical device such as, for example, a vehicle transmission.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a perspective view of one embodiment of the present invention;

FIG. 2 shows a plan view of a mating surface of the present invention;

FIGS. 3 and 4 show a sectional view through lines 3-3 and 4-4 of FIG. 2 respectively;

FIG. 5 shows a plan view of a bearing element of the present invention;

FIG. 6 shows a staking process for retaining the bearing element within a receptor;

FIG. 8 shows an alternative embodiment of a receptor;

FIG. 8 shows a side view of the alternative embodiment of the retainer through line 8-8, of FIG. 7;

FIG. 9 shows a support provided in the base of the receptor;

FIG. 10 shows a bearing element disposed within a mating surface of the alternative embodiment;

FIG. 11 shows a cross-sectional view of an alternative embodiment of the present invention;

FIG. 12 is a side view along lines 12-12 of FIG. 11;

FIG. 13 is a further embodiment of the present invention; and

FIG. 14 shows a bearing element disposed in a receptor of the alternative embodiment.

### DETAILED DESCRIPTION

Referring to FIG. 1, a rotational assembly of the present invention is generally shown at 10. The rotational assembly includes a mating surface 12 and an interlocking surface 14. The interlocking surface 14 is engaged with a cooperable interlocking member (not shown) in a known manner to drive the rotational assembly 10 in a circumferential direction around axis a. A plurality of receptors 16 are disposed in the mating surface 12 of the rotational assembly 10. A bearing element 18 is received in each receptor 16 to reduce frictional interaction between the mating surface 12 of the rotational assembly 10 and a complimentary mating surface 20 of an interacting component 22.

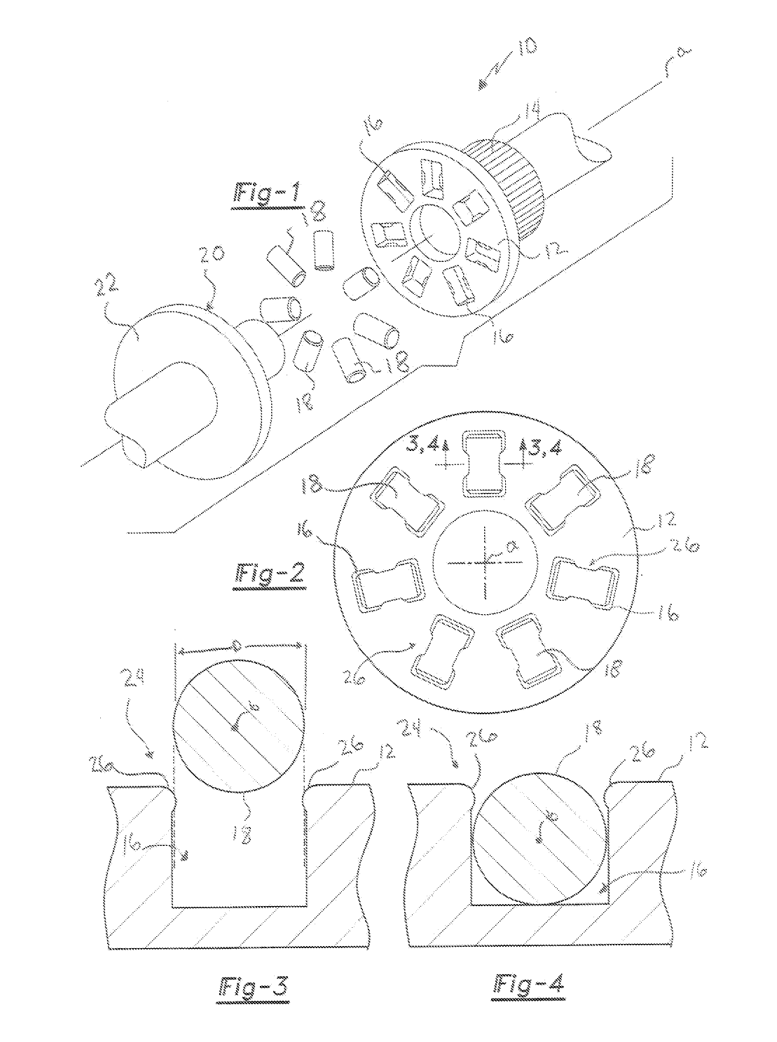

Referring now to FIGS. 2-4, the bearing elements 18 are received by the receptors 16 in a manner that allows the bearing element 18 to rotate freely while disposed in the receptor 16. A clasp 24 is formed at the receptor 16 in the mating surface 12 for retaining the bearing element 18 within the receptor 16.

In this embodiment, the clasp 24 is defined as opposing protuberances 26 formed at the receptor 16 prior to inserting the bearing element 18. It should be understood that the receptors 16 are arranged in succession corresponding to the divergent directions of the mating surface 12 and the complimentary mating surface 20. Each protuberance 26 is formed prior to inserting the bearing element 18 into the receptor 16 by way of machining or alternative forming method. The distance between each protuberance 26 is slightly less than the diameter D of the bearing element 18. Therefore, upon insertion of the bearing element 18 into the receptor 16, the bearing element 18 is retained by protuberances 26. It should be understood by those of ordinary skill in the art that the bearing element 18 is received into the receptor 16 by way of to a “snap fit” interaction.

The bearing element 18 also includes a rotational axis b that is disposed slightly below an uppermost portion of the mating surface 12. Therefore, a circumferential portion of the bearing element 18 extends upwardly from the uppermost portion of the mating surface 12 providing support between the complimentary mating surface 20 and the mating surface 12 so that only ten to twenty percent of the surface area of the bearing element 18 is exposed. Therefore, when the mating surface 12 is moving in a divergent direction to the complimentary mating surface 20 the bearing element rotates between the two surfaces 14, 20 providing a low friction interaction. It should further be understood by those of ordinary skill in the art that the bearing element 18 can take the form of a pin or a sphere depending upon the nature of the rotational assembly 10.

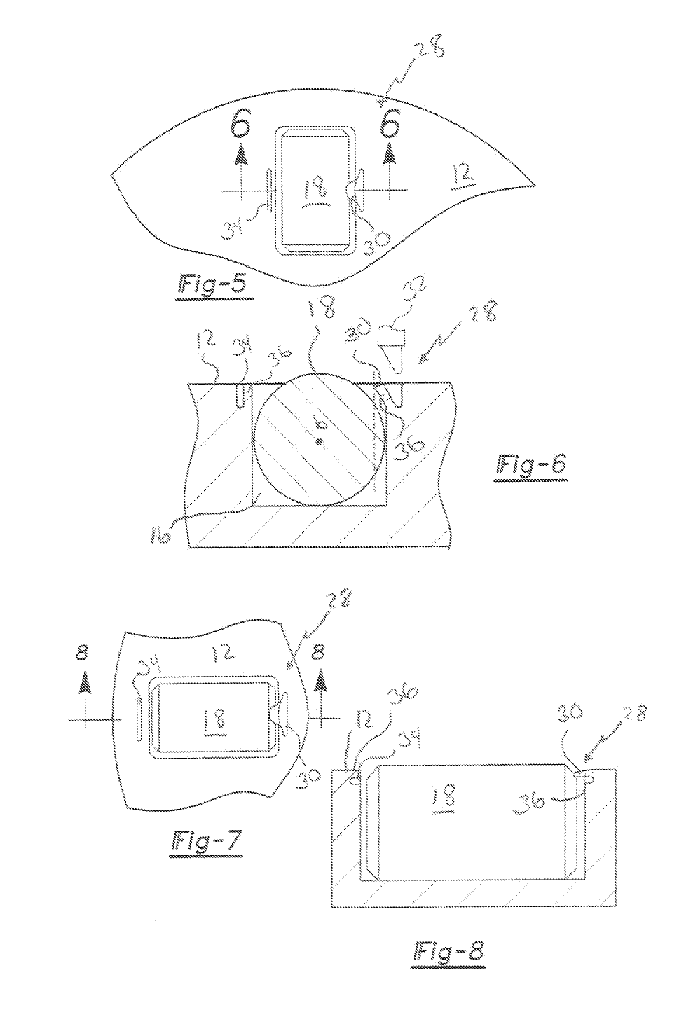

An alternative embodiment of the clasp 24 is generally shown at 28 of FIGS. 5 through 8. The alternate clasp 28 in this embodiment is not preformed in the mating surface 12. In this embodiment, a staking operation is performed to deform the mating surface 12 for defining a stake 30 to retain the bearing element 18 within the receptor 16. The stake 30 is formed by way of a staking element 32 in a known manner. Alternatively, a small notch 34 is preformed in the mating surface 12 defining a web 36 that is merely deformed by the staking element 32 so that the distance between opposing webs 36 is less than a diameter D of the bearing element 18.

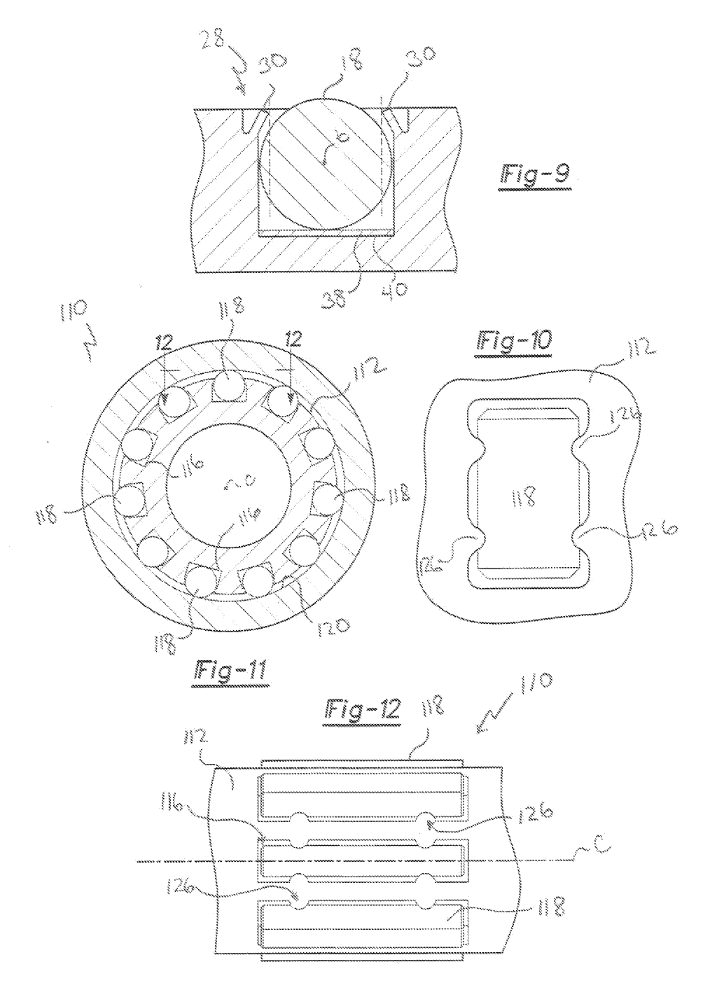

FIGS. 5 and 6 show the stake 30 located along a radial surface of the bearing element 18. Alternatively, FIGS. 7 and 8 show the stake 30 located along an axis b of the bearing element 18. It should also be understood to those of skill in the art that a single protuberance 26 or stake 30 will suffice to retain the bearing element 18 within the receptor 16 because the bearing element 18 need only be retained during assembly of the rotational assembly 10. Once the complimentary mating surface 20 is positioned adjacent the mating surface 12 the bearing element is permanently retained within the receptor 16 by way of the interaction between the two surfaces 12, 20.

Referring now to FIG. 9, a support 38 is located at a base 40 of the receptor 16. In some instances, the rotational assembly 10 is heat treated to provide strength to the assembly in a known manner. However, it is sometimes desirable not to heat treat the rotational assembly 10 and make use of a softer metallic substrate. In this instance, a bearing element 18 could deform a base 40 of the mating surface 12 rendering the bearing element 18 not functional for its intended purpose. Therefore, it would be desirable to provide a heat treated or otherwise strengthened support 38 at the base 40 of the receptor 16 to provide additional support to the bearing element 18.

FIGS. 10 through 14 disclose an alternative rotational assembly 110 where the mating surface 112 is not planar, but cylindrical. In the following exemplary embodiment, like elements to the prior embodiment are merely identified in the 100 series of elements. The alternative assembly 110 includes an assembly axis c around which the mating surface 112 is disposed. The mating surface 112 is adjacent a complimentary mating surface 120 each of which rotate around axis c in divergent directions around axis c. It should be understood by those of skill in the art that this embodiment includes clockwise and counterclockwise rotation of either of the mating surfaces 112, 120 around axis c. Bearing elements 118 are disposed in receptors 116 and support the complimentary mating surface 120 against the mating surface 12. The bearing elements 18 are received by the receptor 16 in a manner similar to that defined above. Furthermore, the clasp 124 used to retain the bearing element 118 within the receptor 116 is similar to that set forth above in the prior embodiment. FIG. 10 represents parallel opposing protuberances 26 that define the clasp 28.

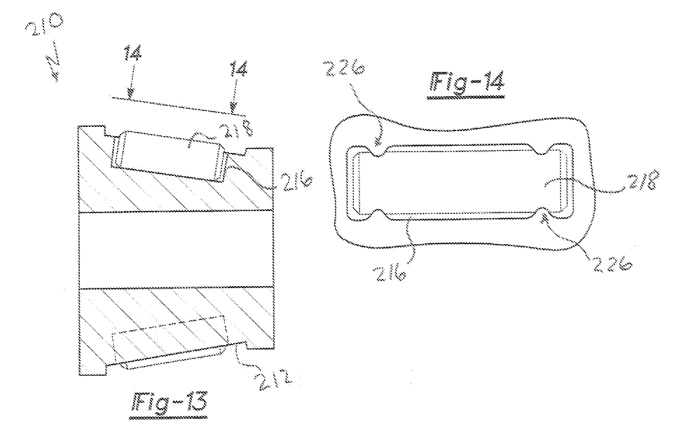

FIGS. 13 and 14 show a further embodiment where like elements to that described above are defined in the 200 series of element numbers. In this embodiment of the rotational assembly 210 the mating surface 212 is not cylindrical but frustoconical by design. However, the frustoconical mating surface 212 makes use of the bearing elements to 18, which are received by receptors 216 in a similar manner as described above. In this embodiment, the bearing element 218 is retained in receptor 216 by way of protuberances 226 similar to that defined above.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of reducing friction between adjacent surfaces of two components of a mechanical device moving in divergent directions, comprising the steps of:
forming a plurality of receptors in at least one of said adjacent surfaces, said receptors being arranged in succession corresponding to the divergent directions of said two elements;
inserting a bearing element into each of said plurality of receptors with said bearing element supporting said adjacent surfaces of said two components; and
providing a clasp at said receptors for retaining said bearing element within said receptor with said bearing element rotating relative to said adjacent surfaces thereby reducing friction between said adjacent surfaces when said adjacent surfaces are moving in divergent directions.

2. The method set forth in claim 1, wherein said step of providing a clasp is further defined by staking said adjacent surface adjacent said receptor for retaining said bearing element in said receptor.

3. The method set forth in claim 1, wherein said step of providing a clasp is further defined by preforming said clasp into said adjacent surface at said receptor prior to inserting said bearing element into said receptor.

4. The method set forth in claim 1, wherein said step of providing a clasp is further defined by forming opposing protuberances at said receptor with said opposing protuberances being spaced a distance D being less than a diameter of said bearing element.

5. The method set forth in claim 1, wherein said step of providing a bearing element is further defined as providing a cylindrical pin or a sphere.

6. The method set forth in claim 1, wherein said step of arranging said receptors in succession is further defined as arranging said receptors in a loop around shaft splines of a differential gear.

7. The method set forth in claim 1, wherein said step of inserting said bearing element into said receptor is further defined by disposing an axis of said bearing element inwardly of said adjacent surface defining said receptor.

8. A rotational assembly having a mating surface and an interlocking surface disposed in driving engagement with a cooperable interlocking member of a driving mechanism, comprising:
a plurality of receptors defined in said mating surface;
a bearing element received in each of said plurality of receptors for reducing frictional interaction between said mating surface of said rotational assembly and a complimentary mating surface of an interacting component; and
a retainer defined in said mating surface at each of said receptors providing rotational retention of each of said bearing elements within its corresponding receptor.

9. The rotational assembly set forth in claim 8, wherein each of said receptors comprises a pocket having a depth and said bearing element comprises a diameter exceeding said depth of said pocket allowing a circumferential portion of said bearing element to extend outwardly of said mating surface.

10. The rotational assembly set forth in claim 9, wherein each of said receptors define width being greater than said diameter of said bearing element.

11. The rotational assembly set forth in claim 10, wherein said retainer comprises cooperable protuberances having a spacing that is less than said diameter of said bearing element.

12. The rotational assembly set forth in claim 8, wherein said bearing element comprises a cylinder or a sphere.

13. The rotational assembly set forth in claim 8, wherein said retainer comprises a staked protuberance.

14. The rotational assembly set forth in claim 8, wherein said bearing element includes a rotational axis disposed inwardly of said mating surface of said rotational element.

15. The rotational assembly set forth in claim 8, wherein said bearing element prevents said mating surface of said rotational assembly from contacting the complimentary mating surface of the interacting component.
